(19) United States
(12) Patent Application Publication
(10) Pub. No.: US 2023/0107987 A1
(43) Pub. Date: Apr. 6, 2023

(54) A detection method of nonlinear ultrasonic guided wave with carrier modulation

(71) Applicant: South China University of Technology, Guangzhou, Guangdong (CN)

(72) Inventors: Xiaobin HONG, Guangzhou, Guangdong (CN); Yuan LIU, Guangzhou, Guangdong (CN)

(21) Appl. No.: 17/040,490

(22) PCT Filed: May 23, 2019
(86) PCT No.: PCT/CN2019/088043

§ 371 Date: Sep. 22, 2020

(30) Foreign Application Priority Data
May 22, 2019 (CN) 201910427160.7

(51) Int. Cl. G01M 7/02

(52) U.S. Cl. CPC G01M 7/025

(57) ABSTRACT

A detection method of nonlinear ultrasonic guided wave with carrier modulation is described. The high and low frequency components are determined according to the frequency response characteristics of the detection object, and the high-frequency components are processed by delay and combined with the low-frequency components to form a carrier modulation signal. The single excitation and single receiving mode are adopted for signal acquisition. The carrier modulation signal with high frequency and low frequency components is excited by a single transducer. The nonlinear modulation effect is produced by the interaction between the carrier signal and the damage, and the signals are collected by the receiving transducer through transmission method. According to the arrival time of high frequency components and the time of end reflection echo, the signal is intercepted and analyzed. After filtering and normalization processing, the received signal is decomposed by empirical mode decomposition (EMD). According to the decomposed IMF spectrum information, IMF components including fundamental frequency and nonlinear frequency components are used for signal reconstruction. The difference frequency components generated by the modulation of high-frequency and low-frequency, namely nonlinear components, are extracted, and the non-linear coefficient is calculated. The damage degree of materials is evaluated based on the nonlinear coefficient of nondamaged state.

### FIELD OF THE INVENTION

The present invention relates to the field of nondestructive testing technology and structural health monitoring technology, in particular to a carrier modulation nonlinear ultrasonic guided wave damage detection method.

### BACKGROUND OF THE INVENTION

Large-scale engineering structures such as aerospace vehicles, bridge engineering, ship engineering, and oil pipelines are affected by the external environment during long-term service, such as fatigue, corrosion effects, and material aging. Defects will inevitably form on the surface or inside of the engineering structures. The existence of defects seriously damages the structural integrity of engineering materials, resulting in a sharp decline in their performance, thus causing serious accidents in the actual use process. To avoid sudden accidents, structural health monitoring technology has been widely concerned and developed. Structural health monitoring (SHM) is an on-line monitoring technology. On the premise of not destroying the integrity of structural parts, the structural response signals are collected and analyzed, and damage location and degree of damage are evaluated. To ensure the reliability of engineering materials in the process of use, it is of great importance to take effective detection methods to detect the damage of materials.

Ultrasonic guided wave testing technology has been widely used in the field of non-destructive testing due to the advantages of long propagation distance, high detection efficiency, low cost and harmless to human body. Ultrasonic guided wave detection technology is mainly divided into linear ultrasonic guided wave and nonlinear ultrasonic guided wave detection technology. Linear ultrasonic guided wave detection technology usually detects the damage according to the change of time and amplitude characteristics. It has high detection accuracy and sensitivity for the cracks and holes whose size is larger than the wavelength. However, when detecting micro cracks, fatigue damage and delamination damage, the change of time and amplitude is not obvious, which leads to inaccurate detection results. Nonlinear ultrasonic guided wave detection technology is not limited by the propagation wavelength, and is very sensitive to micro defects or state changes in materials. Nonlinear ultrasonic guided wave detection technology usually analyzes the received signal in frequency domain, and mainly observes the nonlinear effects of materials, such as high-order harmonics and modulated side lobes. Among them, the high-order harmonic method cannot accurately describe the nonlinear effects caused by defects due to the influence of instrument nonlinearity and material nonlinearity. The modulation sidelobe method can more accurately describe the nonlinear effect of the defect through the nonlinear effect generated by the interaction of the two ultrasonic waves with the defect in the propagation path. However, the modulation sidelobe method requires multiple excitation sources, and the nonlinear component is very weak compared to the fundamental frequency component, which seriously affects the accuracy of detection.

### SUMMARY OF THE INVENTION

To solve the above technical problems, the purpose of the present invention is to provide a carrier modulated nonlinear ultrasonic guided wave damage detection method.

The purpose of the invention is realized through the following technical scheme:

A detection method of nonlinear ultrasonic guided wave with carrier modulation, Include the following steps:

Step S1: The high and low frequency components are determined according to the frequency response characteristics of the detection object, and the high-frequency components are processed by delay and combined with the low-frequency components to form a carrier modulation signal.

Step S2: The single excitation and single receiving mode are adopted for signal acquisition. The carrier modulation signal with high frequency and low frequency components is excited by a single transducer. The nonlinear modulation effect is produced by the interaction between the carrier signal and the damage, and the signals are collected by the receiving transducer through transmission method.

Step S3: According to the arrival time of high frequency components and the time of end reflection echo, the signal is intercepted and analyzed. After filtering and normalization processing, the received signal is decomposed by empirical mode decomposition (EMD). According to the decomposed IMF spectrum information, IMF components including fundamental frequency and nonlinear frequency components are used for signal reconstruction.

Step S4: The difference frequency components generated by the modulation of high-frequency and low-frequency, namely nonlinear components, are extracted, and the non-linear coefficient is calculated. The damage degree of materials is evaluated based on the nonlinear coefficient of nondamaged state.

Compared with the prior art, one or more embodiments of the present invention may have the following advantages:

It can effectively and accurately detect the small damages with weak reflection signals of engineering materials;

A single piezoelectric transducer is used to realize the excitation of multi frequency component signals through carrier modulation signal, which reduces the cost of modulated nonlinear ultrasonic guided wave detection method;

The difference frequency (i.e. the difference between high frequency and low frequency) components in the high and low frequency modulated side lobe is extracted from the spectrum information of IMF components, to improve the accuracy of modulation nonlinear ultrasonic detection method and evaluate the damage degree.

### BRIEF DESCRIPTION OF THE DRAWINGS

FIG. 1 is flow chart of carrier modulated nonlinear ultrasonic guided wave damage detection method;

FIG. 2 is frame diagram of carrier modulated nonlinear ultrasonic testing system;

FIGS. 3a and 3b are the swept frequency signal in time-domain and frequency-domain;

FIG. 4 is the excitation signal of carrier modulation including high and low frequency component;

FIG. 5 Schematic diagram of carrier modulated nonlinear ultrasonic guided wave detection;

FIG. 6 is intercepted time domain signal with difference frequency sidelobe;

FIG. 7 is the IMFs (Intrinsic Mode Function) after EMD (Empirical Mode Decomposition);

FIG. 8 is the frequency spectrum of IMFs;

FIG. 9 is the frequency spectrum of reconstructed signal including fundamental frequency and difference frequency components.

### DETAILED DESCRIPTION OF THE INVENTION

To make the purpose, technical scheme and advantages of the invention clearer, the present invention will be further described in detail in combination with the embodiment and the attached drawings.

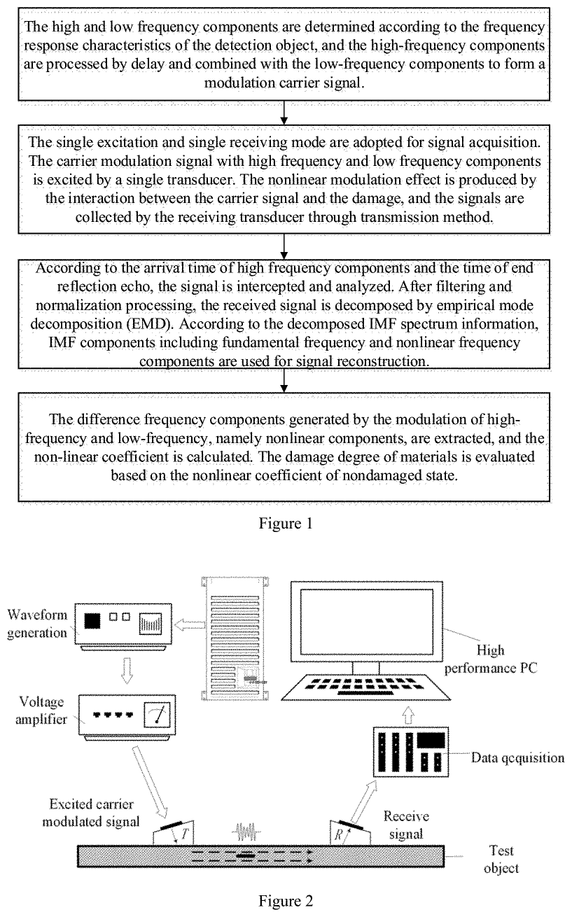

As shown in FIG. 1, it is a detection method of nonlinear ultrasonic guided wave with carrier modulation, which is realized by the detection system in FIG. 2. The method specifically includes the following steps:

In step 10, 280 kHz and 160 kHz are used as high-frequency and low-frequency components according to the frequency response characteristics of the detection object, and the high-frequency components are processed by delay and combined with the low-frequency components to form a carrier modulation signal.

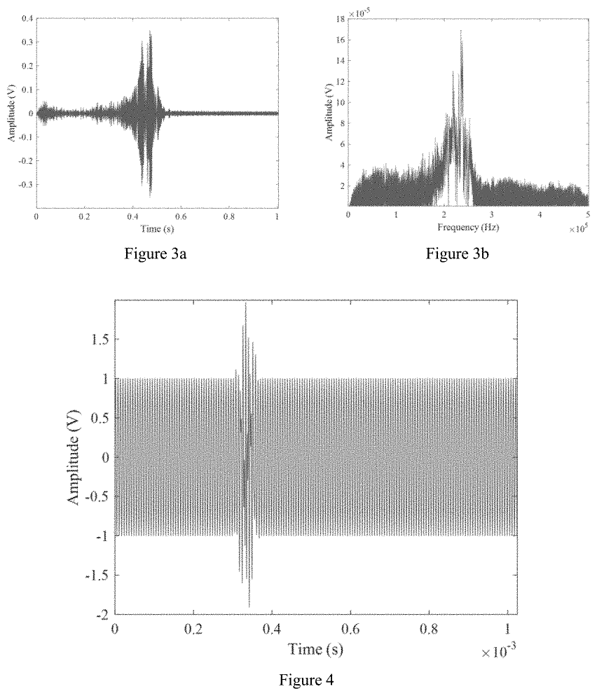

The swept-frequency experiment is carried out on the detected object. The time domain signal is shown in FIG. 3a and the frequency domain signal is shown in FIG. 3B. 280 kHz and 160 kHz are used as high and low frequency components to form a carrier modulation signal. The used frequency response intensity is close to ½ of the maximum response value, and the modulation effect is good. The carrier modulated excitation signal is shown in FIG. 4.

The low frequency component is continuous sine wave, and the high frequency component is 20 peak sine waves modulated by Hanning window. The high frequency component is processed by delay and combined with low frequency component to form a carrier modulation signal. The delay time of high frequency component is greater than that of low frequency signal arriving at receiving transducer.

In step 20, the ultrasonic testing signal with carrier modulation is used to realize the damage detection through single excitation single receiving, that is, the excitation signal with high frequency and low frequency component is excited by a single transducer. The nonlinear effect is generated by the interaction between the carrier modulation signal and the damage, and the receiving signal with nonlinear component is collected by a single transducer.

Both excitation and receiving sensors use PZT transducer with positive and negative piezoelectric effect. T is the excitation transducer to excite the carrier modulation signal with high and low frequency components, and R is the receiving transducer. The received transmission signal contains the non-linear modulation sidelobe generated by the interaction between the carrier modulation signal and the damage.

When ultrasonic wave propagates in nonlinear medium, the waveform will be distorted and deformed. Nonlinear modulation is a kind of the nonlinear characteristics of materials, which is represented by energy redistribution in frequency spectrum.

The carrier modulation signal including two frequency components: high frequency component processed by delay and low frequency components. Suppose the carrier modulation signal is u⁽⁰⁾(x,t)=A₀₁ cos(ω₁τ)+A₀₂ cos(ω₂τ). According to the mechanism of nonlinear effect, the received signal includes high frequency component, low frequency component, nonlinear modulation component and nonlinear harmonic component after the interaction between the signal and damage. The nonlinear modulation component is divided into amplitude modulation and frequency modulation, as shown in formula (1):

$$\begin{matrix}u ( x , t ) = {u}^{( 0 )} + β {u}^{( 1 )} \\ = {A}_{01} cos ( {ω}_{1} τ ) + {A}_{02} cos ( {ω}_{2} τ ) + x β \{ - \frac{{A}_{01}^{2} {k}_{1}^{2}}{8} cos ( 2 {ω}_{1} τ ) - \\ \frac{{A}_{02}^{2} {k}_{2}^{2}}{8} cos ( 2 {ω}_{2} τ ) + \\ \frac{{A}_{01} {A}_{02} {k}_{1} {k}_{2}}{4} [ cos ( {ω}_{1} - {ω}_{2} ) τ - cos ( {ω}_{1} + {ω}_{2} ) τ ] \}\end{matrix} \qquad ( 1 )$$

From the perspective of frequency distribution, the above formula contains the fundamental frequency ω₁ and ω₂, second harmonic 2ω₁ and 2ω₂, as well as sum frequency ω₁+ω₂ and difference frequency ω₁-ω₂. The difference frequency ω₁-ω₂ is used for further analysis.

In step 30, according to the arrival time of high frequency components and the time of end reflection echo, the signal is intercepted and analyzed. After filtering and normalization, EMD is used to decompose the received signal, and the IMF components which including the fundamental frequency and nonlinear frequency components are used for signal reconstruction according to the spectrum of IMFs.

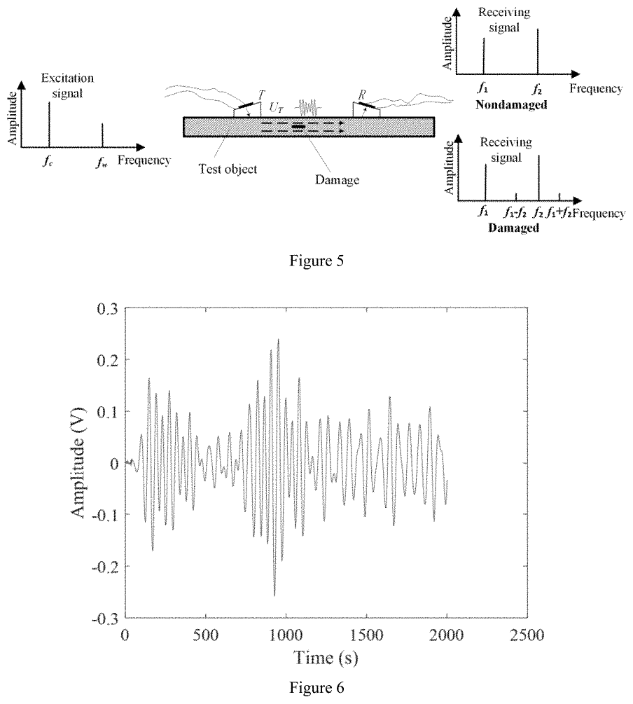

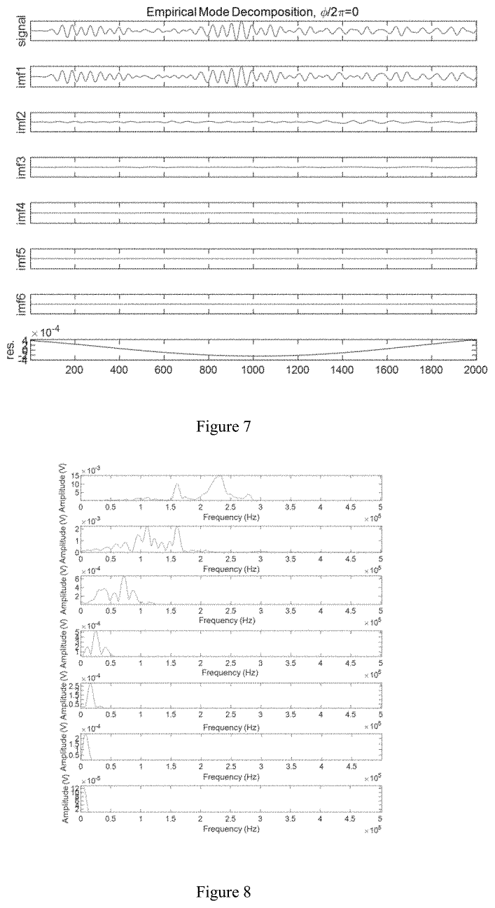

The high-frequency component has set a time delay, and the time to reach the receiving transducer is later than that of the low-frequency component, and the high-frequency component is accompanied by the low-frequency component in the whole propagation path. To obtain accurate modulation sidelobe information, a certain length of signal is intercepted for analysis according to the arrival time of high frequency components and the reflection echo. The starting point of the intercepted signal is the arrival time of high frequency component, and the end is the time when the end reflection echo reaches the receiving transducer. The intercepted signal is shown in FIG. 6. The intercepted signal is filtered and normalized to eliminate the error caused by external factors such as sensors. The intercepted signal contains the fundamental frequency and the nonlinear components generated by the interaction between the fundamental frequency and the damage. EMD decomposition is performed, and FIG. 7 is the EMD decomposition result. Spectrum analysis of each IMF component is carried out, as shown in FIG. 8. The IMF components which including fundamental frequency and difference frequency components generated by the interaction between the fundamental signal and the damage are used for signal reconstruction.

In step 40, the difference frequency components generated by the modulation of high-frequency and low-frequency are extracted, and the nonlinear coefficients are calculated. The damage degree of the tested object is evaluated based on the nonlinear coefficient of nondamaged state. The nonlinear coefficient is the ratio of the energy of modulation difference frequency to the energy of fundamental frequency.

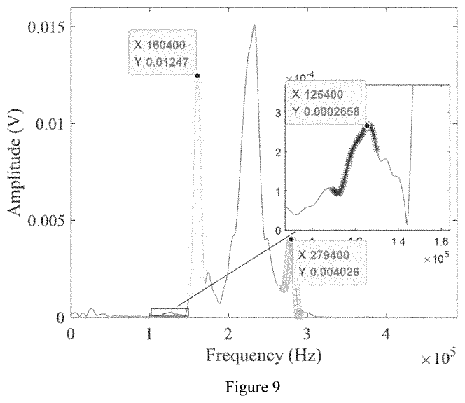

Fourier transform is applied to the reconstructed signal. FIG. 9 shows the spectrum of the reconstructed signal. According to the principle of nonlinear acoustic wave modulation, the nonlinear coefficient is calculated as the ratio of the energy of differential frequency component to the energy of fundamental frequency signal. The damage degree of the tested object is evaluated based on the nonlinear coefficient of nondamaged state, and (0-1.5], (1.5-3] and (3-] were defined as no damage, mild damage and severe damage respectively.

Although the embodiments disclosed in the present invention are as above, the contents described are only for the convenience of understanding the present invention, and are not used to limit the invention. Any person skilled in the technical field of the invention may make any modifications and changes in the form and details of the implementation without departing from the spirit and scope disclosed by the invention, but the scope of patent protection of the invention shall still be subject to the scope defined in the attached claims.

What is claimed is:

1. A detection method of nonlinear ultrasonic guided wave with carrier modulation is characterized in that the method comprises the following steps:
Step S1: The high and low frequency components are determined according to the frequency response characteristics of the detection object, and the high-frequency components are processed by delay and combined with the low-frequency components to form a carrier modulation signal;
Step S2: The single excitation and single receiving mode are adopted for signal acquisition, the carrier modulation signal with high frequency and low frequency components is excited by a single transducer, the nonlinear modulation effect is produced by the interaction between the carrier signal and the damage, and the signals are collected by the receiving transducer through transmission method;
Step S3: According to the arrival time of high frequency components and the time of end reflection echo, the signal is intercepted and analyzed, after filtering and normalization processing, the received signal is decomposed by empirical mode decomposition (EMD), according to the decomposed IMF spectrum information, IMF components including fundamental frequency and nonlinear frequency components are used for signal reconstruction;
Step S4: The difference frequency components generated by the modulation of high-frequency and low-frequency, namely nonlinear components, are extracted, and the non-linear coefficient is calculated, the damage degree of materials is evaluated based on the nonlinear coefficient of nondamaged state.

2. The detection method of nonlinear ultrasonic guided wave with carrier modulation of claim 1, wherein Step S1, the carrier modulation signal composed of high-frequency component with delay processing and low-frequency component is a single signal source, and the selected high-frequency component and low-frequency component are two frequency components on the left and right sides whose response intensity is close to ½ of the maximum response value.

3. The detection method of nonlinear ultrasonic guided wave with carrier modulation of claim 1, wherein Step S1, the low frequency component is continuous sine wave, and the high frequency component is 20 peak sine waves modulated by Hanning window, the high frequency component is processed by delay and combined with low frequency component to form a carrier modulation signal, the delay time of high frequency component is greater than that of low frequency signal arriving at receiving transducer.

4. The detection method of nonlinear ultrasonic guided wave with carrier modulation of claim 1, wherein Step S2, the single excitation transducer generates the excitation signal with two frequency components, the single excitation single receiving mode is used for signal acquisition, the carrier signal is excited and modulated by a single ultrasonic transducer, and the transmission signal is received by a single ultrasonic transducer after damage.

5. The detection method of nonlinear ultrasonic guided wave with carrier modulation of claim 1, wherein Step S3, the intercepted signal should contain the fundamental frequency and the nonlinear component which generated by the interaction between fundamental frequency component and damage, the starting point of the intercepted signal is the arrival time of high frequency component, and the end is the time when the end reflection echo reaches the receiving transducer.

6. The detection method of nonlinear ultrasonic guided wave with carrier modulation of claim 1, wherein Step S3, the normalization process is applied before signal decomposition, that is, the time domain signal is normalized and then analyzed to eliminate the error caused by the external factors of the sensor.

7. The detection method of nonlinear ultrasonic guided wave with carrier modulation of claim 1, wherein Step S3, the signal reconstruction is based on the spectrum information of IMF components of empirical mode decomposition, and the IMF components which including fundamental frequency and difference frequency components are used for signal reconstruction.

8. The detection method of nonlinear ultrasonic guided wave with carrier modulation of claim 1, wherein Step S4, the nonlinear coefficient is the ratio of the energy of modulation difference frequency to the energy of fundamental frequency.

9. The detection method of nonlinear ultrasonic guided wave with carrier modulation of claim 1, wherein Step S4, the damage degree of the tested object is evaluated based on the nonlinear coefficient of nondamaged state, and (0-1.5βₛ], (1.5βₛ-3βₛ] and (3βₛ-] were defined as no damage, mild damage and severe damage respectively.
